(19) United States
(12) Patent Application Publication
(10) Pub. No.: US 2020/0264534 A1
(43) Pub. Date: Aug. 20, 2020

(54) DEVELOPMENT DEVICE AND IMAGE FORMING APPARATUS

(71) Applicant: KYOCERA Document Solutions Inc., Osaka (JP)

(72) Inventors: Hiroaki OHASHI, Osaka-shi (JP); Hirofumi TSUJI, Osaka-shi (JP); Hiroaki TAKAI, Osaka-shi (JP); Masahiro UENO, Osaka-shi (JP); Yasutaka HASHIMOTO, Osaka-shi (JP); Tomoyasu YAMADA, Osaka-shi (JP)

(73) Assignee: KYOCERA Document Solutions Inc., Osaka (JP)

(21) Appl. No.: 16/775,921

(22) Filed: Jan. 29, 2020

(30) Foreign Application Priority Data
Feb. 19, 2019 (JP) 2019-027750

(51) Int. Cl. G03G 15/08

(52) U.S. Cl. CPC G03G 15/0812

(57) ABSTRACT

A development device includes a developer carrier, a housing, a layer thickness regulating member and an attachment member. The developer carrier carries a developer developing an electrostatic latent image formed on an image carrier, the developer carrier rotating around an axis. The housing stores the developer carrier and the developer, and has an opening through which the developer carrier is exposed. The layer thickness regulating member is disposed so as to form a gap between the layer thickness regulating member and the developer carrier and regulates a layer thickness of the developer carried on the developer carrier. The attachment member is made of a material has the same thermal expansion property as the layer thickness regulating member. The layer thickness regulating member is fixed to the attachment member using only an adhesive.

### INCORPORATION BY REFERENCE

This application is based on and claims the benefit of priority from Japanese patent application No. 2019-027750 filed on Feb. 19, 2019, which is incorporated by reference in its entirety.

### BACKGROUND

The present disclosure relates to a development device which develops an electrostatic latent image by a toner and an image forming apparatus including the development device.

A development device using a two-component developer is provided with a development blade facing a development sleeve to regulate a layer thickness of the developer on the development sleeve. A blade gap (a gap between the development sleeve and the development blade) is conventionally adjusted by putting a thickness gauge between the development blade and the development sleeve and fastening the development blade by a screw while adjusting the gap between the development sleeve and the development blade. However, in recent years, as a size of the toner becomes small for high image quality, the developer layer on the development roller is required to be thin, and the tolerance of the blade gap tends to be severe because of necessity for narrowing the blade gap.

Conventionally, because fastening by the screw causes slight waving, warpage and deformation of the development blade, a fine adjustment of the blade gap by fastening the screw requires a considerable skill. Then, a technique to adjust the blade gap is discussed. For example, there is a configuration that the both end portions (corresponding to the non-image forming area) of the development blade are fastened to the development housing with a screw while the portion corresponding to the image forming area is fixed with an adhesive. Alternatively, there is another configuration that the gap setting member made of resin is pressed against the development sleeve at both the end portions (corresponding to the non-image forming area) of the development blade to adjust the gap.

However, in the case where the development blade is directly adhered to the development housing, distortion or peeling of the adhesive may occur owing to a difference in coefficient of thermal expansion between the development housing (made of resin, conventionally) and the development blade (made of metal, conventionally). In the case where the resin gap setting member is used, considering the tolerance of resin product and the attachment tolerance, the tolerance of the blade gap at the time of mass production is limited to about ±0.1, and if the tolerance is required to be lower than that, the yield becomes very bad. Additionally, there is a possibility that when abrasion powder of the resin product is mixed with the developer, an output image may be adversely affected.

### SUMMARY

In accordance with an aspect of the present disclosure, a development device includes a developer carrier, a housing, a layer thickness regulating member and an attachment member. The developer carrier carries a developer developing an electrostatic latent image formed on an image carrier. The developer carrier rotates around an axis. The housing stores the developer carrier and the developer, and has an opening through which the developer carrier is exposed. The layer thickness regulating member is disposed so as to form a gap between the layer thickness regulating member and the developer carrier and regulates a layer thickness of the developer carried on the developer carrier. The attachment member is made of a material has the same thermal expansion property as the layer thickness regulating member. The layer thickness regulating member is fixed to the attachment member using only an adhesive.

In accordance with an aspect of the present disclosure, an image forming apparatus includes the development device develops the electrostatic latent image.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an inner structure of a printer according to one embodiment of the present disclosure.

FIG. 2 is a perspective view showing a development device according to the embodiment of the present disclosure.

FIG. 3 is a sectional view showing the development device before a development blade is attached, according to the embodiment of the present disclosure.

FIG. 4 is a sectional view showing the development device according to the embodiment of the present disclosure.

FIG. 5 is a sectional view showing the development device before the development blade is attached, according to the embodiment of the present disclosure.

FIG. 6 is a sectional view showing the development device according to a modified example of the embodiment of the present disclosure.

FIG. 7 is a sectional view showing the development device according to a modified example of the embodiment of the present disclosure.

FIG. 8 is a sectional view showing the development device according to a modified example of the embodiment of the present disclosure.

### DETAILED DESCRIPTION

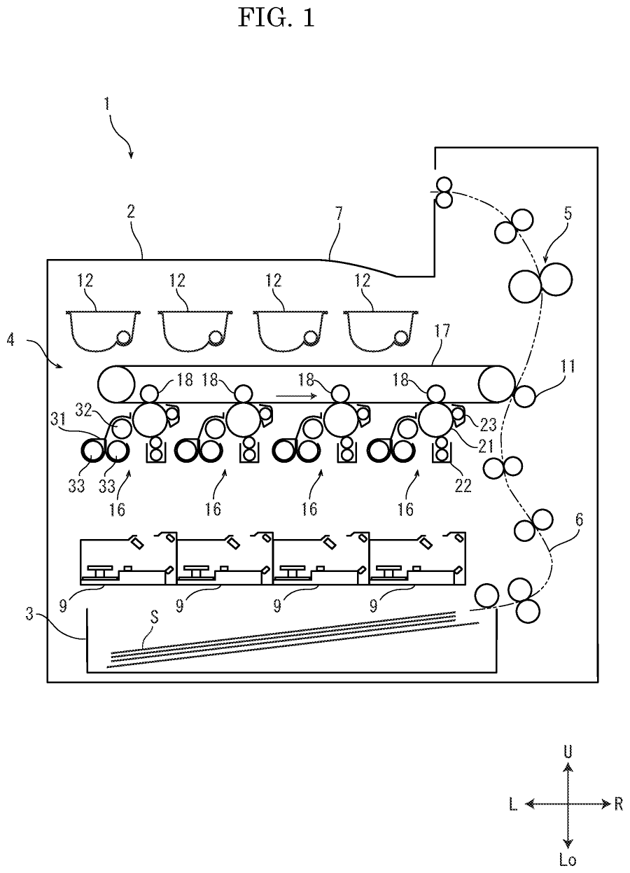

Hereinafter, a printer 1 (an example of an image forming apparatus) and a development device 16 according to on embodiment of the present disclosure will be described with reference to the drawings. FIG. is a front view schematically showing an inner structure of the printer 1. In the following description, a near side (a front side) of a paper surface of FIG. 1 is defined to be a front side of the printer 1, and a left-and-right direction is defined based on a direction in which the printer 1 is viewed from the front side. In each figure, U, Lo, L, R, Fr and Rr respectively show an upper side, a lower side, a left side, a right side, a front side and a rear side.

The printer 1 includes a box-shaped casing 2. In the casing 2, a sheet feeding device 3 which feeds a sheet S to a conveyance path 6, an image forming part 4 which forms a toner image on the sheet S, a fixing device 5 which fixes the toner image on the sheet S and a discharge part 7 which discharges the sheet S on which the toner image is fixed.

The image forming part 4 includes a photosensitive drum 21, a charging device 22, an exposure device 9, a developer container 12, a development device 16, an intermediate transferring belt 41, a primary transferring roller 42, a secondary transferring roller 11 and a cleaning device 23. The photosensitive drum 21 is driven to be rotated. The charging device 22 charges the photosensitive drum 21. The exposure device 9 emits laser light based on an image data to the photosensitive drum 21 to form an electrostatic latent image on the photosensitive drum 21. The developer container 12 supplies a developer containing a toner to the development device 16. The development device 16 develops the electrostatic latent image by the toner to form a toner image. The intermediate transferring belt 41 is wound around a drive roller and a driven roller. The primary transferring roller 42 transfers the toner image to the intermediate transferring belt 41. The secondary transferring roller 11 transfers the toner image on the intermediate transferring belt 41 to the sheet S. The cleaning device 23 cleans the surface of the photosensitive drum 21. The printer 1 is provided with four sets of the photosensitive drum 21, the charging device 22, the exposure device 9, the developer container 12, the development device 16, the primary transferring roller 42 and the cleaning device 23, and configured to form a color image using the toners of four colors. The present disclosure may be applied to an image forming apparatus which forms an image using the toner of one color, or the toners of three or five or more colors.

Next, an image forming operation of the printer 1 will be described. When the printer 1 receives an image data from an exterior computer or the like, the sheet S is fed to the conveyance path 6 from the sheet feeding device 3. Additionally, on the surface of the charged photosensitive drum 21, an electrostatic latent image is formed by the exposure device 9 based on the image data. The developer is supplied to the housing 31 from the developer container 12, and then agitated by the screws 33. The two screws 33 convey the developer in opposite directions to circulate the developer in the housing 31. The developer is carried on the magnetic roller 32 by magnetic force between the carrier and the magnetic roller 32. The toner contained in the carried developer is carried on the electrostatic latent image by a potential difference between the magnetic roller 32 and the photosensitive drum 21. As a result, the toner image is formed.

The toner images formed on the photosensitive drums 21 are overlapped and transferred on the intermediate transferring belt 41 by the primary transferring rollers 42. The toner image transferred on the intermediate transferring belt 41 is transferred on the sheet S by the secondary transferring roller 11, and then fixed on the sheet S by the fixing device 5. The sheet S on which the toner image is fixed is discharged to the discharge part 7.

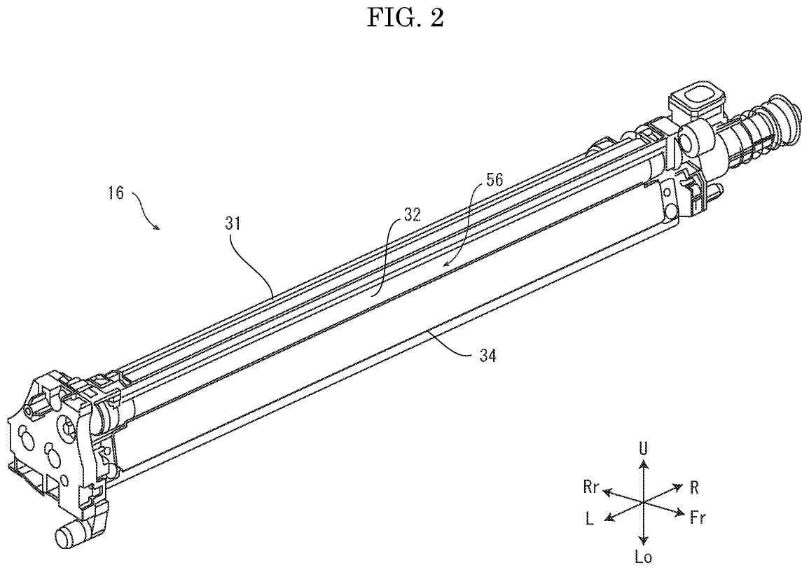

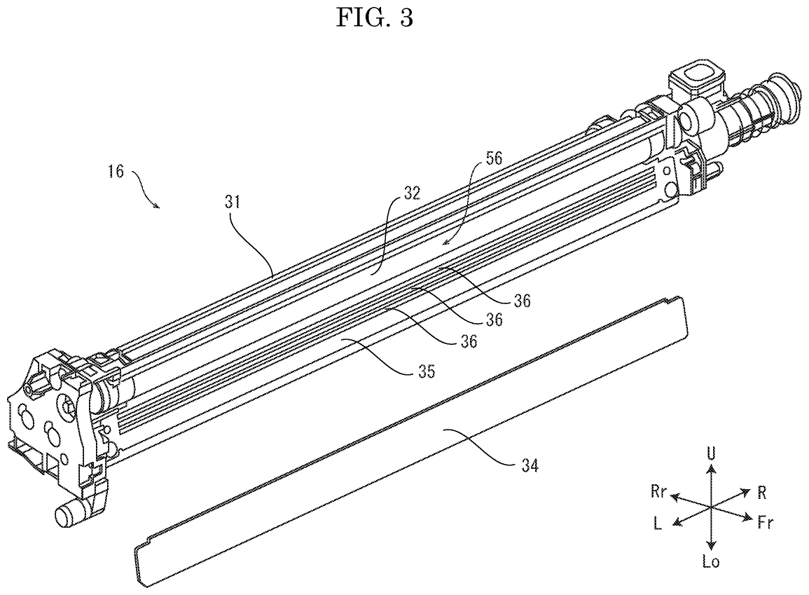

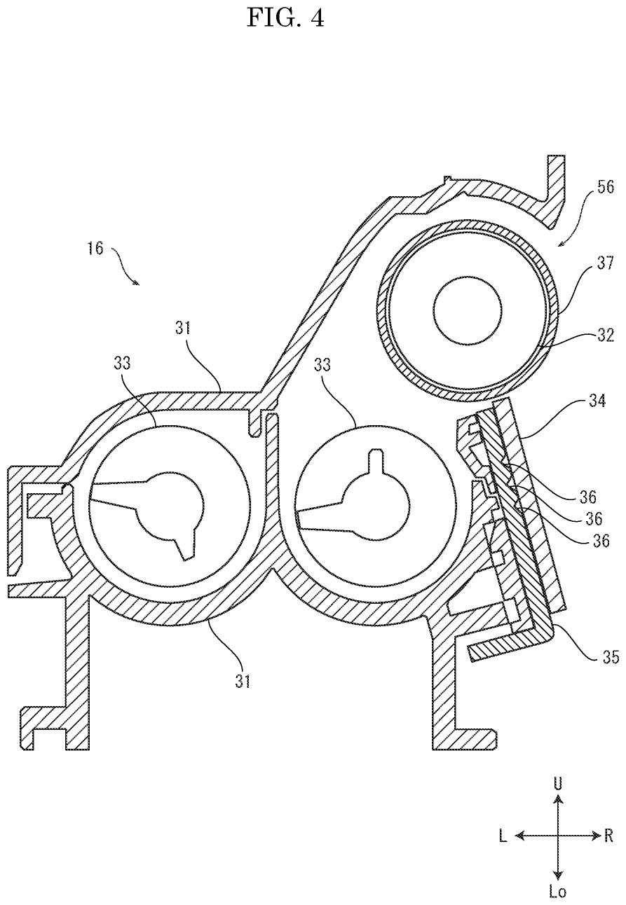

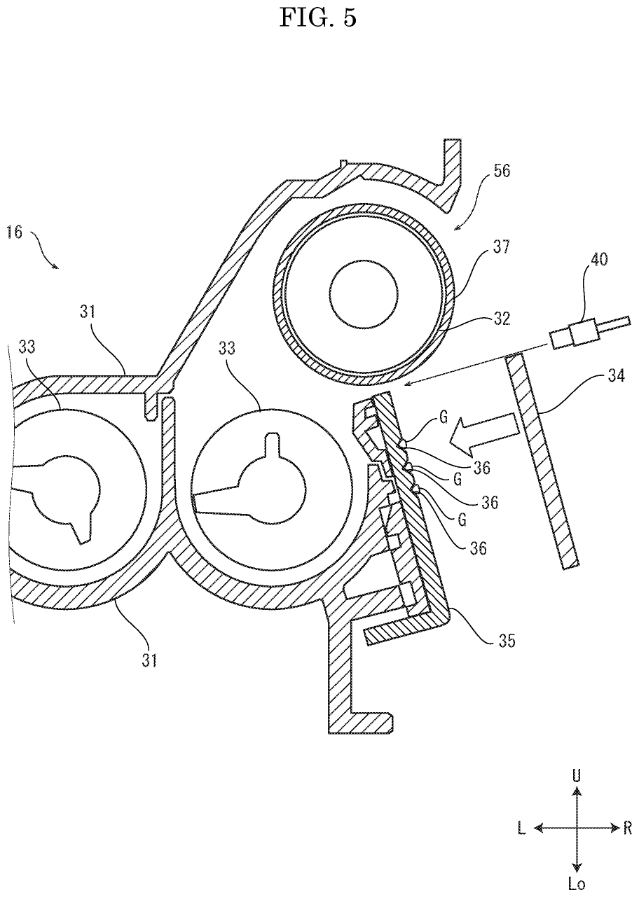

Next, with reference to FIG. 2 to FIG. 5, a development blade 34 (an example a layer thickness regulating member) will be described. FIG. 2 is a perspective view showing the development device 16. FIG. 3 is a perspective view showing the development device 16 before the development blade 34 is attached. FIG. 4 is a sectional view showing the development device 16. FIG. 5 is a sectional view showing the development device 16 before the development blade 34 is attached.

The development device 16 includes a development sleeve 37 (an example of a developer carrier), the housing 31, the development blade 34 (an example of a layer thickness regulating member) and an attachment member 35. The development sleeve 37 carries the developer. The housing 31 stores the development sleeve 37 and the developer, and has an opening 56 through which the development sleeve 37 is exposed. The development blade 34 is disposed so as to face the development sleeve 37 via a gap, and regulates a layer thickness of the developer carried on the development sleeve 37. The attachment member is made of the same type of material as the development blade 34, and fixed to the housing 31. The development blade 34 is fixed to the attachment member 35 using an adhesive G.

The magnetic roller 32 is covered with the development sleeve 37. The development sleeve 37 is made of non-magnetic material, and formed into a cylindrical shape. The development sleeve 37 is supported by the housing 31 in a rotatable manner in a predetermined direction.

The housing 31 is formed into a box-like shape whose longitudinal direction is along the front-and-rear direction. The magnetic roller 32 and the two screws 33 are disposed inside the housing 31 parallel to each other with their axial directions along the front-and-rear direction. The two screws 33 are disposed in the bottom portion of the housing 31 side by side in the left-and-right direction, and the magnetic roller 32 is disposed above the right screw 33. The housing 31 has the opening 56 on a right side of the magnetic roller 32. The outer circumferential face of the magnetic roller 32 exposed through the opening 56 faces the outer circumferential face of the photosensitive drum 21 via a predetermined gap. Between the housing 31 and the developer container 2, a supply path (not shown) for the developer is provided. The developer is a two-component developer containing a toner and a carrier, for example.

The development blade 34 is an approximately rectangular plate-shaped member whose longitudinal direction is along the front-and-rear direction, and has the same length as the development sleeve 37 in the front-and-rear direction.

The attachment member 35 is a member to which the development blade 34 is adhered. The attachment member 35 is a plate like member having the same size as the development blade 34, and fastened to the housing 31 with a screw or the like below the opening 56. The attachment member 35 is made of the same type of material as the development blade 34. The same type of material as the development blade 34 shows the same material as the development blade 34 or a material in which a difference of a coefficient of thermal expansion between the development blade 34 and the attachment member 35 is within a predetermined range, such as stainless steel. The development blade 34 is adhered to the attachment member 35 using the adhesive G, and the upper end portion of the development blade 34 faces the outer circumferential face of the development sleeve 37 of the magnetic roller 32 via a predetermined distance.

As shown in FIG. 5, the attachment member 35 has a recess 36 on the face (the right face) facing the development blade 34, and the recess 36 is formed within a range at least corresponding to the electrostatic latent image in the axial direction of the development sleeve 37. The adhesive G is applied to the recess 36. The range corresponding to the electrostatic latent image is a range of the outer circumferential face of the photosensitive drum 21 facing the region where the electrostatic latent image can be formed. In the example shown in the figure, three groove-shaped recesses 36 having a V-shaped cross section are formed along the front-and-rear direction. The recess 36 is formed by engraving, for example.

The adhesive G is preferably a hot-melt adhesive. By controlling the temperature of the hot-melt adhesive, the solidifying time can be adjusted depending on a working time. Additionally, the peeling and the re-adhering are possible by heating.

The blade gap is adjusted by positioning the development blade 34 while measuring the distance of the gap between the development blade 34 and the development sleeve 37 using a high resolution CCD camera 40, for example. The adjustment of the development gap may be performed manually or automatically by a robot.

According to the development device 16 according to the above described embodiment, the development blade 34 is adhered to the attachment member 35 using the adhesive G, so that distortion hardly occurs on the development blade 34 compared with a case where it is fastened by a screw or the like. Additionally, the attachment member 35 is made of the same type of material as the development blade 34 so that the torsion of the development blade 34 and the peeling of the adhesive hardly occur due to the difference of the coefficient of thermal expansion between the attachment member 35 and the development blade 34, compared with a case where the attachment member 35 is made of the different type of material as the development blade 34. Therefore, according to the development device 16 of the present embodiment, it becomes possible to adjust the blade gap easily even if the required tolerance is severe.

According to the development device 16 of the present embodiment, the attachment member 35 has the recess 36 within the range at least corresponding to the electrostatic latent image in the axial direction of the development sleeve 37, and the adhesive G is applied to the recess 36. Therefore, the adhesive G hardly leaks to a side of the development sleeve 37 compared with a case where the recess 36 is not provided.

According to the development device 16 of the present embodiment, a hot-melt adhesive is used as the adhesive G, so that the adjustment of the solidifying time of the adhesive and the peeling and re-adhering of the adhesive by heating become possible. Therefore, it becomes possible to adjust the blade gap correctly compared with a case where an adhesive other than the not-melt adhesive is used.

The above embodiment may be modified as follows.

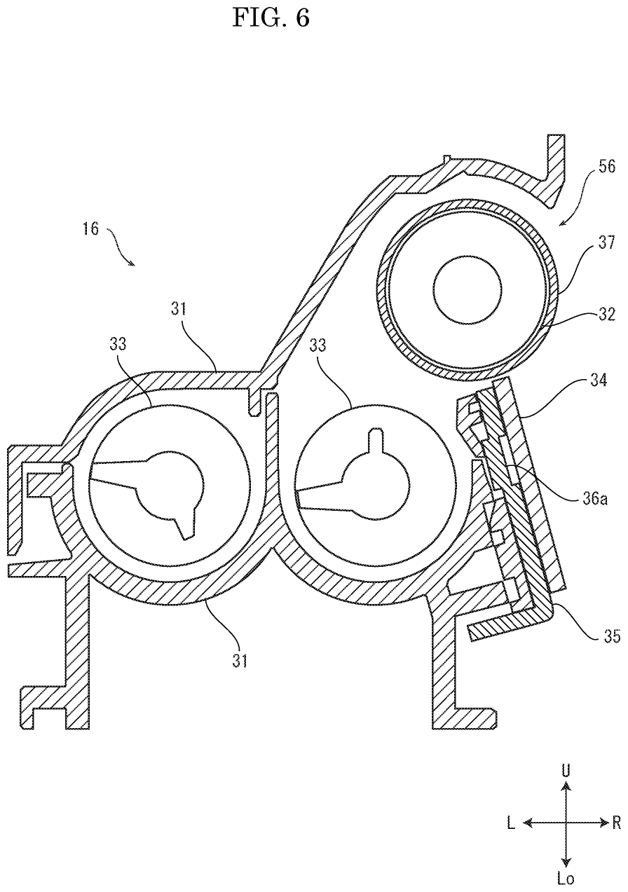

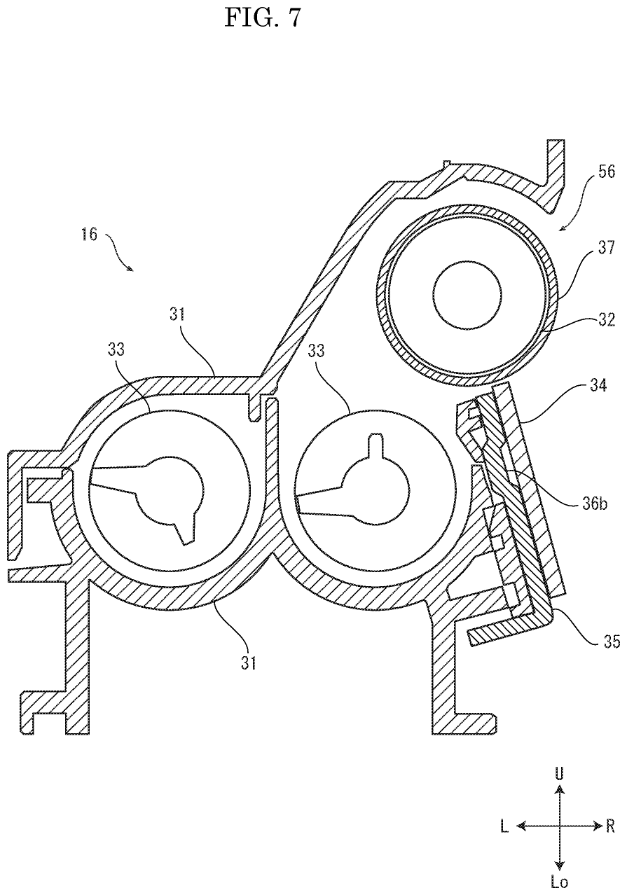

The recess 36 may be formed in the attachment member 35 by any machining method. FIG. 6 and FIG. 7 are sectional views showing the development device 16 of the modified example. The example in FIG. 6 shows the recess 36a formed by half punching (half blanking). The example in FIG. 7 shows the bead shaped recess 36b formed by press machining.

The above embodiment shows an example in which the present disclosure is applied to the development device 16 including the development sleeve 37 as an example of a developer carrier. However, the developer carrier is not limited to the development sleeve 37. For example, the present disclosure may be applied to a touch down type development device which supplies the toner to the photosensitive drum 21 from the magnetic roller 32 via the development roller. In this case, the development roller is used as the developer carrier.

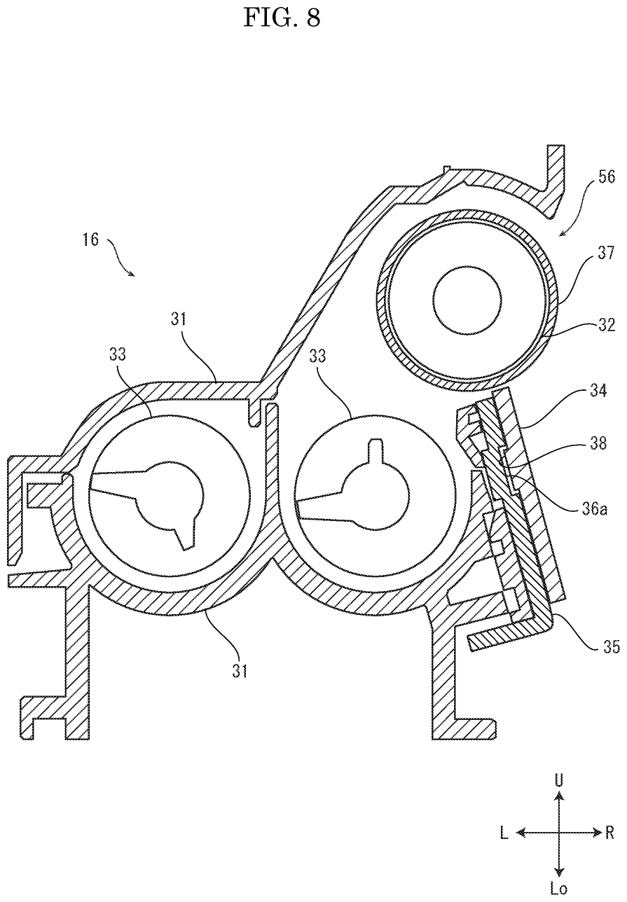

FIG. 8 is a sectional view showing the development device 16 of the modified example. As shown in the figure, the development blade 34 may have a protrusion 38 on the face (the left face) facing the attachment member 35, and the protrusion 38 corresponds to the recess 36 of the attachment member 35. The protrusion 38 has a thickness smaller than a depth of the recess 36, and a length in the upper-and-lower direction shorter than a length of the recess 36 in the upper-and-lower direction. A difference in the length between the protrusion 38 and the recess 36 is an adjustment allowance at the adjusting of the blade gap. According to the configuration, it becomes possible to position the development blade 34 easily before adhering.

The adhesive G may be applied to the portion other than the recess of the attachment member, in addition to the recess. For example, the adhesive may be applied to the lower portion or the lateral portion of the recess. In a case where a plurality of recesses is formed, the adhesive may be applied between the adjacently disposed recesses.

1. A development device comprising:
a developer carrier carrying a developer developing an electrostatic latent image formed on an image carrier, the developer carrier rotating around an axis;
a housing which stores the developer carrier and the developer and has an opening through which the developer carrier is exposed;
a layer thickness regulating member disposed so as to form a gap between the layer thickness regulating member and the developer carrier and regulating a layer thickness of the developer carried on the developer carrier; and
an attachment member made of a material having the same thermal expansion property as the layer thickness regulating member,
wherein the layer thickness regulating member is fixed to the attachment member using only an adhesive.

2. The development device according to claim 1, wherein
the attachment member is made of the same material as the layer thickness regulating member or a material in which a difference of coefficient of thermal expansion between the attachment member and the layer thickness regulating member is within a predetermined range.

3. The development device according to claim 1, wherein
the attachment member has a face facing the layer thickness regulating member,
a recess is formed on the face facing the layer thickness regulating member within a range at least corresponding to the electrostatic latent image in an axial direction of the developer carrier, and
the adhesive is applied to the recess.

4. The development device according to claim 3, wherein
the recess is formed along the axial direction.

5. The development device according to claim 1, wherein
the adhesive is a hot-melt adhesive.

6. An image forming apparatus comprising:
the development device according to claim 1, which develops the electrostatic latent image.
